(19) United States
(12) Patent Application Publication
(10) Pub. No.: US 2009/0289181 A1
(43) Pub. Date: Nov. 26, 2009

(54) Device for Measuring Absorbed Dose in an Ionizing Radiation Field and Use of the Device

(76) Inventor: Göran Wickman, Umea (SE)

Correspondence Address: NIXON & VANDERHYE, PC, 901 NORTH GLEBE ROAD, 11TH FLOOR, ARLINGTON, VA, 22203, US

(21) Appl. No.: 12/227,948

(22) PCT Filed: Jun. 4, 2007
(86) PCT No.: PCT/SE2007/000536

§ 371 Date: Dec. 3, 2008

(30) Foreign Application Priority Data
Jun. 7, 2006 (SE) 0601260-3

(51) Int. Cl. G01T 1/02; G01D 18/00

(52) U.S. Cl. 250/252.1; 250/472.1

(57) ABSTRACT

The present invention concerns an arrangement for the measurement of absorbed dose at a given distance from a radioactive source. The arrangement comprises a detector body (1) of ionization chamber type, comprising two electrode elements (5, 6) arranged at a distance from each other and a measuring chamber (7) arranged between these, containing a medium that constitutes a volume that responds to radiation, a second chamber (12) arranged at a distance from the measuring chamber (7) comprising means for recording changes in the medium, a flow passage (13) that is arranged to pass through one of the electrode elements (5, 6) and to constitute a connection that allows the flow of fluid between the measuring chamber (7) and the second chamber (12), and where the detector body (1) comprises a through bore, an aperture (2), in which the radiation source is arranged during measurement or through which the radiation source is displaced during measurement. The invention concerns also the use of the arrangement.

The present invention concerns an arrangement for the measurement of absorbed dose at a given distance from a radioactive source. To be more precise, it concerns an arrangement for the measurement of the absorbed dose to water in the proximity of a small radioactive source. The invention concerns also the use of the arrangement.

In particular, the invention concerns an arrangement for the determination of the magnitude of the dose absorbed in water at a given radial distance from a radioactive source having the form of a thin wire or small cylinder.

The term “dose absorbed in water” is here used to denote the energy that ionising radiation deposits to the medium per unit of mass. The unit in which absorbed dose is measured is the Gray (Gy), and this has dimensions of joules per kilogram (J/kg). The rate at which energy is deposited is denoted the “dose rate”, and this has units of Gray per second (Gy/s).

In particular, the invention concerns the determination of the dose absorbed in water at a given radial distance from the central axis of a radiation source that has the form of a small cylinder or a thin wire, when the source is completely surrounded by this medium.

Considerations of patient safety during medical radiation therapy mean that it is of utmost importance to be able to predict the biological effect on living human tissue when it is exposed to ionising radiation. The expected effect of the radiation in tissue is strongly correlated to the absorbed dose in the region of interest.

One special form of radiotherapy involves the implantation into the tissue or the organ that is to be treated of one or several thin radioactve wires or small radioactive bodies in the form of cylinders (known as “seeds”). This method of radiotherapy is generally known as brachytherapy. Brachytherapy is carried out in one or several forms at most major hospitals and cancer centres throughout the world. Examples of radiation sources for brachytherapy are seeds or wires containing the gamma-emitting nuclides I-125, Pd-103, Cs-137 and Ir-192; while common beta-emitting radioactive nuclides am Pr-142, Sr-90/Y-90 and P-32.

Wires and seeds often have a diameter that lies within the range 0.5 to 0.8 mm. Seeds often have a length of approximately 5 mm, while wires can have lengths of up to several centimetres.

One common form of treatment using brachytherapy is the permanent implantation of seeds containing I-125 or Pd-103 into the prostate gland for the treatment of prostate cancer. A second, relatively new, method is the post-treatment of damaged areas of the coronary arteries with the aim of preventing restenosis. A radioactive wire or a train of radioactive seeds is in this case introduced into the damaged region of the blood vessel via a catheter. The method is generally known as “intravascular brachytherapy”. The duration of the exposure to radiation, i.e. the duration of the period during which the radiation source is located in the treatment position, can vary from a few minutes up to permanent retention of the radiation source in the tissue of the patient. The amount of radioactive material contained in a radiation source is expressed by the quantity “activity”, which has units of Becquerel (Bq). The activities of radiation sources for use in brachytherapy can differ considerably depending on the type of treatment for which the radiation source is intended to be used. Treatments in which the radiation source remains in the area of treatment for only a few minutes may have activities that are so large that the dose rate at a reference distance of 10 mm may amount to several Gy/minute, while radiation sources that are used for permanent implantation deposit only approximately 0.1 mGy/minute.

In order to be able to guarantee good security relative to the result of the treatment, it is desirable to be able to predict the magnitude of the absorbed dose and its distribution in human tissue, before the radioactive source is inserted into the patient. It is therefore generally recommended that each radiation source that is to be used for brachytherapy is calibrated by the user before radiotherapy commences. In order to be able to satisfy this recommendation, it is required that each hospital, at which brachytherapy is carried out must be able to carry out accurate calibration of each radiation source that is to be used for treatment. Such a calibration involves the determination of the rate at which each such radiation source deposits its radiation dose to water (Gy/s) when the radiation source is completely surrounded by this medium.

The result of such a determination is then to form the basis for the calculation of the radiation dose that the tissues of the patient will receive during the period that the radiation source is located in the organ or tissue.

Thus, as a basis on which to calculate and predict before treatment the distribution of the dose absorbed by the patient's tissue, it is required that the dose rate that the radiation source produces in water at a given radial distance from the central axis of the seeds or the wires that will be used in the treatment is known. The accuracy to which one aspires is such that the measured or calculated dose, or dose rate, is not to deviate from the true value by more than approximately 1%. The radial distance that is recommended for the calibration is 2 mm for radiation sources that are to be used for the treatment of blood vessels, and 10 mm for radiation sources that are to be used for the treatment of tumours. When this reference value has been accurately determined, well-known and recommended algorithms can be applied to calculate the complete dose distribution around the radiation source used in the brachytherapy. However, these algorithms are based on the assumption that the radioactive material is evenly distributed along the longitudinal axis of the radiation source. It is recommended that it is also checked that this really is the case, and this is particularly relevant for such radioactive wires and trains of small radiation sources that are to be used for intravascular radiotherapy. The length of such radiation sources can range from approximately 2 to 6 cm.

Thus, the quality requirements placed on an arrangement for the safe and secure control and measurement of radiation sources that are to be used for brachytherapy are as follows:

It must be possible to calibrate the dose absorbed to water in water of such a source at, for example, a national standards laboratory, and subsequently to maintain this calibration for a sufficiently long period, preferably several years.

The radiation field that extends around the radiation source when this is surrounded by water must not be disturbed by the introduction of the measurement probe, a phenomenon known as “perturbation”.

It must be possible to make the volume of the arrangement that responds to radiation sufficiently small that it allows an acceptable spatial resolution of the radiation dose in water. This requirement means that the extent of the sensitive volume of the arrangement should not exceed approximately 1 mm in either the radial or the axial extent of the radiation source.

The dose response should not depend on the quality, intensity or angle of incidence of the radiation onto the sensitive volume of the arrangement.

It should be possible to read the arrangement directly. The term “read directly” is here used to denote a procedure in which the arrangement produces, for example, an electrical current, the magnitude of which is directly proportional to the dose rate that is present at the measurement point.

Known methods and arrangements that are currently used for the calibration and control of radiation sources for brachytherapy are all very labour-intensive. None of them satisfies the requirements that have been specified above. This is particularly true of the arrangements and methods that are used to control beta-emitting radiation sources intended to be used in intravascular radiotherapy.

The most common arrangement currently used for the calibration of radiation sources for brachytherapy is an ionisation chamber that uses a gas as the sensitive medium. The principle on which an ionisation chamber is based involves a sensitive medium contained in the chamber being subject to radiation, whereby ion pairs are created in a number that is proportional to the energy that is deposited through the interaction of the radiation with the gas. The ions that are created are captured through an electrical field formed between two electrodes. The charge that is captured in this manner can subsequently be measured and used to determine the magnitude of the dose absorbed by the sensitive medium.

The most common form of ionisation chamber intended to be used for the calibration of radiation sources for brachytherapy has the design of a well into which the radiation source that is to be calibrated can be lowered. This form of ionisation chamber is generally known by the term “Well-counter”. The ionisation chamber has the advantage that its technology is based on a simple principle and it shows excellent long-term calibration stability.

One serious disadvantage of this type of detector is that its volume sensitivity is limited, since a gas is used as the sensitive medium. This is a consequence of the fact that gases have low densities. This in turn entails a requirement for a relatively large sensitive volume, such that it is possible to measure with sufficient accuracy the number of ions that the relevant radiation sources create. It has proved to be the case in practice that the sensitive volume that is required must be so large that the gas ionisation chamber is only capable of responding to the energy deposited in a large region around such a radiation source. A consequence of this is that it is not possible to detect local energy peaks or spikes in the radiation field in the vicinity of the radiation source or along it. The use of a gas ionisation chamber is thus limited to being able to measure solely the total activity of the radiation source. Such a measurement must consequently be supplemented with a control of the dose pattern around the radiation source in order to ensure that locations cannot arise in the tissue of the patient at which the actual dose absorbed deviates seriously from the expected dose. This supplementary control is normally carried out using photographic film.

Corrections and calculations are required in order to determine finally the absorbed dose to water at the recommended reference distance. These corrections and calculations are labour-intensive and they may add uncertainty to the calibration procedure.

Examples of other common arrangements for the determination of absorbed dose around radiation sources for brachytherapy are semiconductor diodes and natural diamonds. These arrangements work on the principle whereby the ionising radiation creates free charges in the p-n junctions of a semiconductor or in the atomic lattice of a diamond. The charge that has been created can be collected and measured in order to determine the absorbed dose in the same manner as that used for ionisation chambers. One common feature of the detector principles that have been described is that the electrical charge or current that the ionising radiation has created in the material of the detector that is sensitive to radiation is measured in order to determine the absorbed dose or dose rate. Thus, the result of the measurement can be recorded directly during or immediately after the irradiation of the detector.

A further direct-response method for the measurement of the dose absorbed is that of measuring the light that the energy absorption from the ionising radiation creates in certain materials, known as “scintillating materials”. Certain plastic materials have this property. The light that is created in the scintillating material by the absorption of energy from the radiation can be led via a light-guide to a photomultiplier, which in turn converts the light to an electrical signal, the magnitude of which is proportional to the intensity of the radiation.

The said principles of detection have a considerably better volume sensitivity than the gas ionisation chamber, and in the designs described above have, in the relevant measurement situation, a sensitive volume in the form of a thin plate or a small cylinder with a dimension of approximately 1 mm.

A further type of arrangement for the measurement of absorbed dose is a type that allows the recording after exposure to radiation of some change in the radiation sensitive material of the arrangement that is caused by the radiation. Examples of commonly used detectors of this type are photographic film and thermoluminescence dosimeters.

The blackening of the developed photographic film can be used as a measure of the magnitude of the dose absorbed.

Photographic film emulsions are also available that have been specially produced for the determination of dose absorbed in water, without the need for development. The radiation source is normally placed directly into such a film, when this form of detector is used to determine the dose around a radiation source for brachytherapy. The dose pattern around the radiation source can be estimated after the exposure by mapping the blackening of the film around the radiation source. There is a relationship between the blackening of the film and the dose it has received, and thus the dose pattern can be determined.

A thermoluminescence dosimeter exploits the phenomenon that the exposure to radiation of certain materials causes a certain quantity of the electrons that have been excited by the radiation to remain in an excited state within the material. These electrons are de-excited when the material is subsequently heated, and the quantity of light that is then produced is, under certain conditions, proportional to the absorbed dose that the material has received. It is a common feature of the latter group of detectors that these dosimeters do not allow direct read-out of the dose response.

All of the arrangements described so far that are used for the current purpose lack one or several of the properties that are required by the task. None of them, for example, with the exception of the gas ionisation chamber, can be regarded as being able to satisfy the requirement for high calibration stability during a considerable period. This shortcoming implies that two or more of these arrangements must be used in combination, in order to ensure a sufficiently reliable calibration. Such a procedure is not only labour-intensive: it also involves extensive corrections and calculations that may, in turn, involve increased uncertainty.

There is thus a major need for a reliable arrangement for the task of determining the dose absorbed around small radioactive source that are intended to be implanted into cancer tumours for radiotherapy or to be introduced into blood vessels for the treatment of constrictions.

One aim of the present invention is to offer an arrangement for the measurement of absorbed dose at a given distance from a radioactive source. The invention concerns also the use of the arrangement.

Further aims are to offer an arrangement that:
offers a radiation-sensitive volume that is small relative to the distribution in space of the absorbed dose around a cylindrical radiation source. This means in practice that the extent of the sensitive volume in the radial direction and in the axial direction, given the centre of the central axis of the radiation source as a reference point, should not exceed approximately 1 mm. The radial distance of the measurement point from the central axis of the cylindrical radiation source is to be determined with a precision better than approximately 0.1 mm.
it will be possible to surround, with respect to its radiation-sensitive volume, by water or by other material that absorbs and scatters the radiation from the relevant radiation source in the same manner as water does.
disturbs (perturbs) by its presence in the reference material the radiation field by an insignificant amount from that which otherwise would have arisen.
ensures that the degree of proportionality between the dose absorbed in water and the measured signal does not significantly depend on the energy spectrum of the radiation (the radiation quality).
demonstrates proportionality between the absorbed dose and the measurement signal that does not significantly change with the dose rate or with the magnitude of the absorbed dose.
ensures that the precision of the determination of the absorbed dose or in the dose rate in water is better than a few percent. This means in practice that it must be possible to calibrate the arrangement in water in a radiation field with a known dose rate, and the arrangement subsequently must demonstrate sufficient stability in its dose response over time and irradiation history. It must be possible, for example, to calibrate the sensitivity of the arrangement in one radiation field with a known dose rate, at, for example, a national standards laboratory, and then subsequently to maintain this calibration within the specified tolerance during a long period.

These and other aims are achieved by an arrangement according to the present invention such as it is defined in the characterising parts of the attached patent claims.

The invention is based on a detector of ionisation chamber type in which the radiation-sensitive medium is a dielectric fluid instead of a gas.

It is now well-known that ionisation chambers, known as “liquid ionisation chambers” (LICs), in which the gas has been replaced by a dielectric fluid demonstrate a volume sensitivity that is several hundred times greater than that of gas ionisation chambers. This property means that the sensitive volume of such an ionisation chamber can be made so small that it can be used with sufficiently high resolution for the mapping of the dose pattern in space at a distance of a few millimetres from most of the currently available types of radiation source for brachytherapy.

Fluid ionisation chambers in which the dielectric fluid consists of a mixture of isooctane and tetramethylsilane have demonstrated that they are able to provide a very high calibration stability with time and with irradiation history, while it is at the same time possible to adapt their response with respect to the energy spectrum of the radiation such that it is similar to that of water.

The matrix of the ionisation chamber consists of a styrene copolymer such as, for example, Rexolite®, and its collection electrodes for ions are made from pure graphite, and thus the perturbation of the radiation in water is negligible. Ionisation chambers constructed according to this principle in which the radiation-sensitive volume has the form of a thin plate or a small cylinder have been previously described(Swedish patent no. 9600360-3).

The fundamental principle of the fluid ionisation chamber has been used in the present invention, and thus a fluid ionisation chamber has been constructed whose radiation-sensitive part has the form of a thin-walled, short cylinder. This will be referred to as an “ALIC”, where this is an acronym for (Annular Liquid Ionisation Chamber). The radius of the thin ring can be made equal to the reference distance that is to be applied for the control of the radiation source, for example, 2 mm or 10 mm.

During the calibration of a radiation source, the source can be stepwise displaced through an aperture concentrically arranged relative to the radiation-sensitive ring of the fluid ionisation chamber. When the diameter of the aperture has been carefully adapted to the external diameter of the radiation source, the condition is achieved in which the measurement takes place at a very well-determined radial distance from the central axis of the radiation source.

Designing the sensitive volume as a thin ring means also that the optimal geometry is achieved, in order to obtain the maximum active detector volume at a given radial distance from a cylindrical radiation source.

It has not been possible before this to demonstrate the design of a radiation detector with high volume sensitivity, and one in which the sensitive part has been designed as a thin circular ring. It would appear that the reason for this has been technical problems involved with giving other known and suitable detector materials such a design.

Two ALIC prototypes, one with a ring diameter of 2 mm, the other with a ring diameter of 10 mm, have been constructed and thoroughly tested.

It has proved to be the case that this design of fluid ionisation chamber can satisfy in a very satisfactory manner the requirements that can be placed on an arrangement according to the invention for the calibration of radiation sources for brachytherapy.

The arrangement has a detector body of ionisation chamber type, comprising two ring-shape electrode elements located at a distance from each other and means that are arranged to define, together with the electrode elements in the detector body, a measuring chamber, formed as a short and thin-walled cylinder. This cylinder can be filled with a dielectric fluid. A second chamber is arranged at a distance from the measuring chamber in known manner. Furthermore, a flow passage is arranged through one of the electrode elements, placing the measuring chamber in connection with the second chamber. Furthermore, a means of absorbing changes of volume of the sensitive medium is arranged in the second chamber.

We have found that it is possible for us with this configuration of electrodes to solve in a surprising manner the problem of determining in a very simple and secure way the magnitude of the absorbed dose at a clearly defined radial distance along a radiation source having the form of a wire by displacing this source stepwise through the ring-shaped sensitive volume, and determining at each position along the axial direction of the radiation source the instantaneous ionisation current.

The sensitive volume has the form of a short, thin-walled cylinder. The rectangular intersection area of the cylinder wall can be given dimensions from approximately 0.30×0.30 mm to approximately 1×1 mm, depending on the sensitivity and spatial resolution that are desired.

The dose rates to be measured stretch over a wide range, from approximately 0.1 mGy/minute up to several Gy/minute, depending on the type of radiation source for brachytherapy. Such radiation sources as those intended for permanent implantation have low dose rates, while radiation sources for short-term irradiation via a catheter often have high dose rates.

The lower limit of the dose rate that can be measured with acceptable precision is determined by the magnitude and the stability of the undesired current leakage in the insulation material of the ionisation chamber and in the fluid that is used. A correction for this current must be applied, and the current should not be greater than approximately 50% of the ionisation current. A low polarisation voltage and a large separation of the electrodes in the ionisation chamber are advantageous when the properties of the fluid ionisation chamber are to be accentuated when measuring low dose rates.

The upper limit of the dose rate that can be measured with acceptable precision is determined by the increase in the rate of recombination of those ion pairs that are to be transported through the fluid that takes place when the dose rate increases. A correction must be applied for the decrease in response caused by recombination, and this decrease should not be greater than approximately 2% of the measured ionisation current. A small electrode separation and a high polarisation voltage are advantageous when an ALIC is to be optimised for the measurement of high dose rates.

Thus, a compromise must be reached with respect to the region of dose rate in which it is intended that the ionisation chamber is to be used. It is generally the case that the interval of dose rate that a fluid ionisation chamber of the basic design presented here covers is a maximum of approximately three orders of magnitude. This means that the complete interval of dose rate that all types of radiation source for brachytherapy represent cannot be covered by any one particular polarisation voltage and, in particular, any one electrode separation.

The radial distance to the central point of the fluid ring determines the desired reference distance to the central axis of the radiation source. The two ALIC prototypes that have been constructed and tested both have a ring with a square area of intersection. One has an area of intersection of magnitude 0.5×0.5 mm with a radius of 2 mm, while the second has an area of intersection of 1×1 mm and a radius of 10 mm. The application of an aperture with a hole whose diameter corresponds to the relevant outer diameter of the radiation source enables a good guarantee to be obtained that the radial distance of the measurement point to the central axis of the radiation source is very clearly defined. A detailed description of preferred embodiments of the present invention is given below in order to further clarify the invention. The text contains references to the attached drawings. The invention thus solves the problem of measuring the dose absorbed at a given radial distance from the central axis of a radiation source in the form of a cylinder. The materials that have been tested—Rexolite® for the chamber body and insulator, graphite for the electrodes, and a mixture of isooctane and tetramethylsilane for the sensitive medium—are all such that they absorb and scatter radiation in a manner that corresponds well with the relationships in water and in human tissue. This means that the radiation pattern around the radiation source in water is disturbed to a very small degree by an ALIC that is constructed according to the manner that is presented.

A further interesting field of application for the arrangement is that of monitoring, for example, the activity concentration of a flow of radioactive gas or fluid that is led through a tube that passes through the aperture of the chamber, in installations for the production of, for example, radioactive isotopes.

### BRIEF DESCRIPTION OF THE DRAWINGS

FIG. 1 shows an overview of an ALIC in two projections, and its connection to an electrometer by a triaxial cable.

FIG. 2 shows a sectional view of an ALIC according to one embodiment of the present invention, adapted for the calibration of low and medium strength radiation sources for brachytherapy at a reference distance of 10 mm.

FIG. 3 shows an ALIC with an accessory for the centring of a radiation source for brachytherapy for calibration at a reference distance of 10 mm.

FIG. 4 shows schematically the mechanical arrangement that is used during tests of the reproducibility of an ALIC when measuring the dose pattern around radiation sources for brachytherapy containing 30 mCi Cs-137 or approximately 1 m Ci I-125.

FIG. 5 shows in block diagram form the arrangement of an ALIC, linear positioning unit, drive unit, computer and electrometer that is used.

FIG. 6 shows a graph of theoretical calculations of the energy response of an ALIC for photons, with various different mixtures of fluids.

FIG. 7 shows results obtained during tests of an ALIC in which the sensitive ring-shaped volume was designed in the form of a short thin-walled cylinder with a radius of 2 mm, a length of 0.5 mm, and wall thickness of 0.5 mm. A Cs-137 radiation source for brachytherapy with an activity of 30 mCi, length 5 mm and external diameter 1 mm was used.

FIG. 8 shows results obtained during long-term tests of a detector in which the sensitive ring-shaped volume was designed in the form of a thin cylinder with a radius of 10 mm, a length of 1.0 mm, and wall thickness of 1.0 mm.

FIG. 9 shows results of tests in which an ALIC was used in which the sensitive ring-shaped volume had an intersectional area of 1×1 mm and a radius of 10 mm. An I-125 radiation source for brachytherapy with an activity of 1 mCi, length 4.8 mm and external diameter 0.8 mm was used.

### DETAILED DESCRIPTION OF THE INVENTION

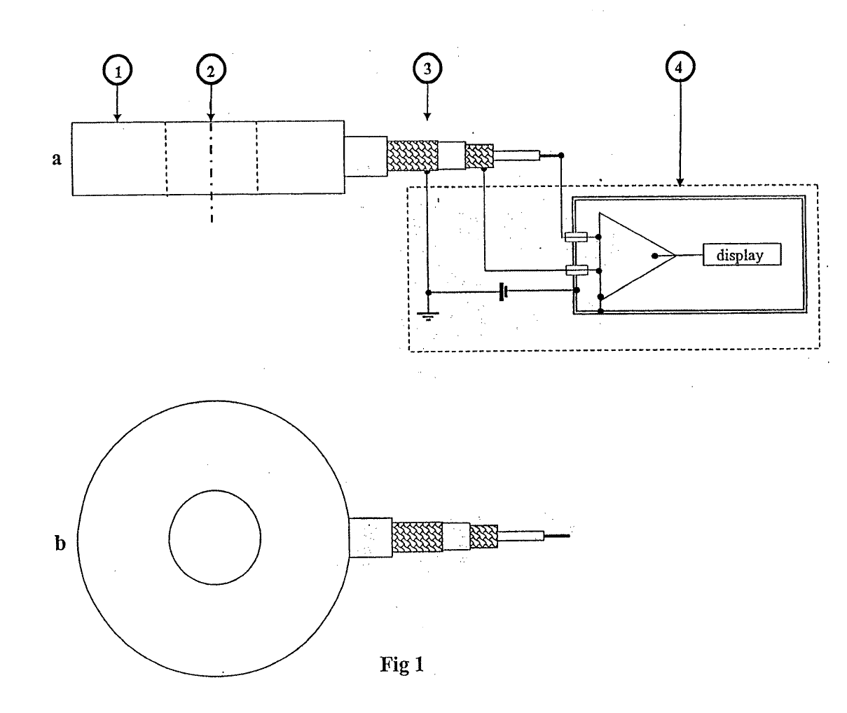

FIG. 1 shows schematically two projections, a and b, of a detector of ionisation chamber. type according to the present invention. The detector comprises. an essentially cylindrical body 1 with a cylindrical and concentric bore 2. The detector is provided with a triaxial cable 3 for connection to a conventional electrometer 4 used for measurements of ionisation chambers.

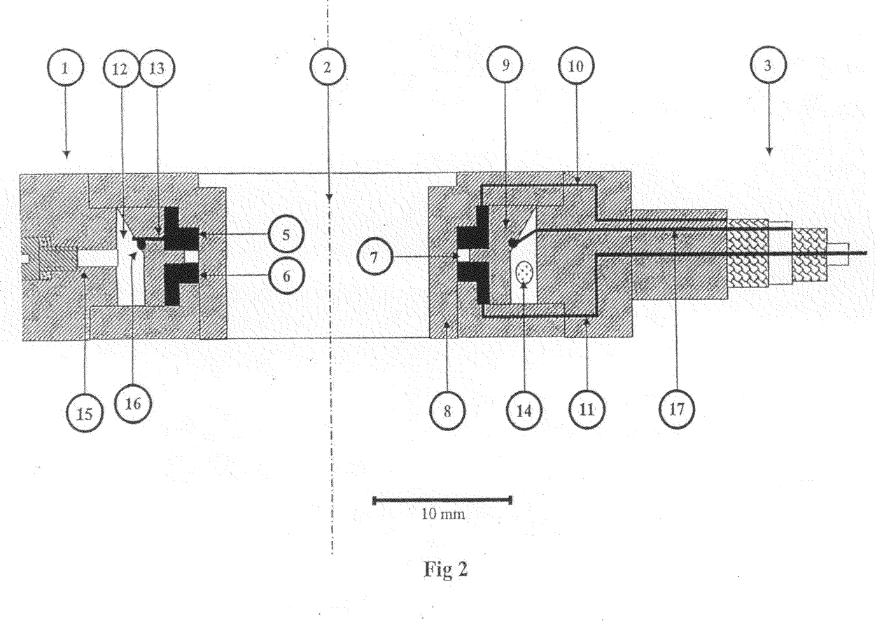

FIG. 2 shows in sectional view an ionisation chamber 1 according to the present invention for calibration at a reference distance of 10 mm. Two essentially ring-shaped and concentrically located electrodes 5 and 6 are located at a certain distance outside of the cylindrical bore 2. It is preferable that these are made of graphite, that they are parallel to each other, and that they are arranged at a certain distance from each other.

An essentially ring-shaped compartment 7 is limited between the electrodes along the axial direction of the ionisation chamber, intended for the sensitive medium of the detector. This space constitutes the volume of the ionisation chamber that is sensitive to radiation. The compartment 7 is limited radially by the cylindrical walls 8 and 9. These walls are manufactured from a non-conducting material. This material also withstands chemical influence from the sensitive medium of the detector and it withstands influence from ionising radiation. It is preferable that the material of the walls is an electrically insulating styrene copolymer such as, for example, Rexolite®. The electrodes 5 and 6 are connected by electrical cables 10 and 11 through the body of the chamber to the outer conducting layer of the triaxial cable and its central conductor, respectively. The outer conductor and the central conductor of the triaxial cable connect in this manner the two electrodes 5 and 6 of the ionisation chamber to the electrometer 4, FIG. 1. The electrometer applies a difference in electrical potential to the electrodes, and it reads the electrical charge that is collected by the electrode 6. The charge collected corresponds to the energy deposited by the radiation into the measurement compartment 7, and it is proportional to the absorbed dose. Electrometers with the function that has been described, such as the PTW-Unidos Universal Dosemeter and the Keithley Electrometer model 617, are well-known within ionisation chamber technology and will not be further discussed here.

The field strength that is created by the polarisation voltage between the electrodes and that is optimal with respect to the dose rate that is to be measured and the thickness of the layer of fluid, which is determined by the distance along the axial direction between the two electrodes, may lie within the range 0.3 to 3 MV/m.

Furthermore, an additional coaxial compartment 12, having essentially the form of a ring, is arranged in the body of the ionisation chamber. This second compartment is arranged outside of the first compartment 7.

Furthermore, the two compartments 7 and 12 are placed in flow connection with each other through a passage 13. This passage is arranged to pass through the chamber body and through the electrode 5. The diameter of the passage should be approximately 0.3 mm.

The sensitive medium in the present invention is a fluid that, in this embodiment, is introduced through a passage 15. The opening of the passage can be preferably closed by a threaded plug after the chamber has been filled with fluid.

The sensitive medium is a fluid that has a temperature-dependent variation in volume that differs from that of the chamber body, and thus the detector may be subject to pressure effects in the chamber body created during operation. These pressure effects may adversely affect the measurement precision.

This problem has been solved in known manner by the addition of a gas bubble 14 to the fluid. The size and the location of the gas bubble and the diameter of the flow passage 13 are designed such that the gas cannot migrate into the measurement compartment 7 of the ionisation chamber.

Furthermore, a ring-shaped protective electrode 16 has been inserted into the outer compartment 12 for the radiation-sensitive medium. The protective electrode is preferably a platinum wire of thickness approximately 0.2 mm, which passes along the external surface of the chamber wall 9 in the compartment 12. The location of the protective electrode at the chamber wall is such that the electrode is in contact with the column of fluid in the flow passage 13. The protective electrode 16 is connected to the conductive central layer of the triaxial cable, through the fluid in the compartment 12 and the chamber body. The connection of the ionisation chamber to the measurement equipment 4 via the triaxial cable, FIG. 1, means that the protective electrode will have the same electrical voltage as the measurement electrode 6. The protective electrode 16 prevents in an effective manner ions that have been created in the fluid that is located in the compartment 12 and in the flow passage 13 during irradiation from passing to the measurement electrode 6 and in this way contributing in an undesired manner to the measured signal. The task of the protective electrode is thus to place the fluid that is present outside of the measurement volume of the chamber, and that becomes conducting under the influence of radiation, at the same electrical potential, from the point of view of its field strength, as the collecting electrode. The introduction of a protective electrode into the fluid ionisation chamber with a design of the sensitive volume that differs from that preferred here has also been shown to improve significantly the precision of such fluid ionisation chambers as that, for example, described in the Swedish patent number 9600360-3, from Wickman and Holmstrom.

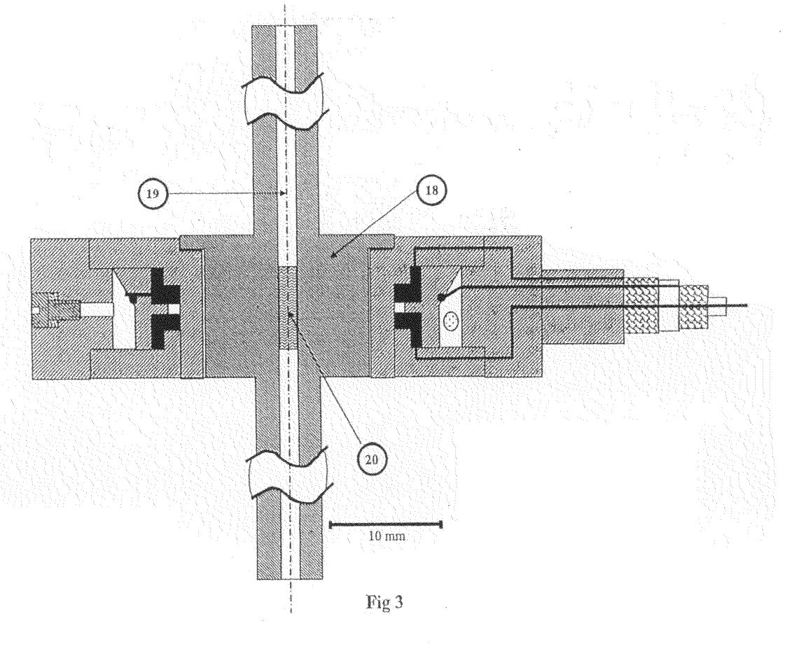

FIG. 3 shows in sectional view an example of an accessory 18 with an aperture 19 adapted such that it can position a radiation source 20 concentrically relative to the fluid volume 7 of the ionisation chamber that responds to radiation. The material in the accessory 18 must scatter and absorb radiation in a manner that corresponds closely to that of water, it is preferable that this material is Rexolite® or Solid Water™. A radiation source 20 is located centred relative to the volume 7 of the ionisation chamber that responds to radiation.

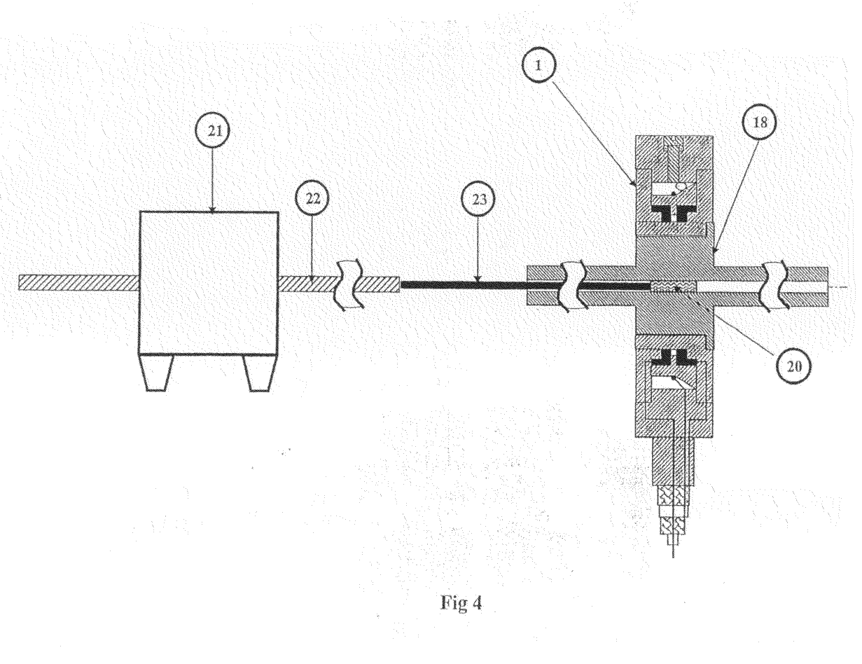

FIG. 4 illustrates schematically an arrangement for positioning the radiation source in an axial direction relative to the volume of the ionisation chamber that responds to radiation when an ALIC according to the present invention is used for calibration.

A commonly used size for radiation sources of seed-nature used in brachytherapy has a physical outer diameter of approximately 0.8 mm and a length of approximately 5 mm. A linear manipulator 21 with a guide screw 22 connected to a piston 23 is used in order to be able to determine not only the activity extent along the axial direction of the radiation source, but also the homogeneity of its activity distribution and the absorbed dose at the central point along the longitudinal axis of the radiation source. Stepwise changes in position of the radiation source 20 can be made along the axial direction relative to the sensitive volume 7 of the ionisation chamber with the aid of this arrangement.

We have successfully used a Haydon Switch & Instrument hybrid non-captive linear actuator, size 11″, as linear manipulator 21. This actuator has a guide screw that allows a linear positioning in steps with a resolution better than 0.025 mm. It is possible to control, in turn, the linear actuator by computer, using software developed in Labview.

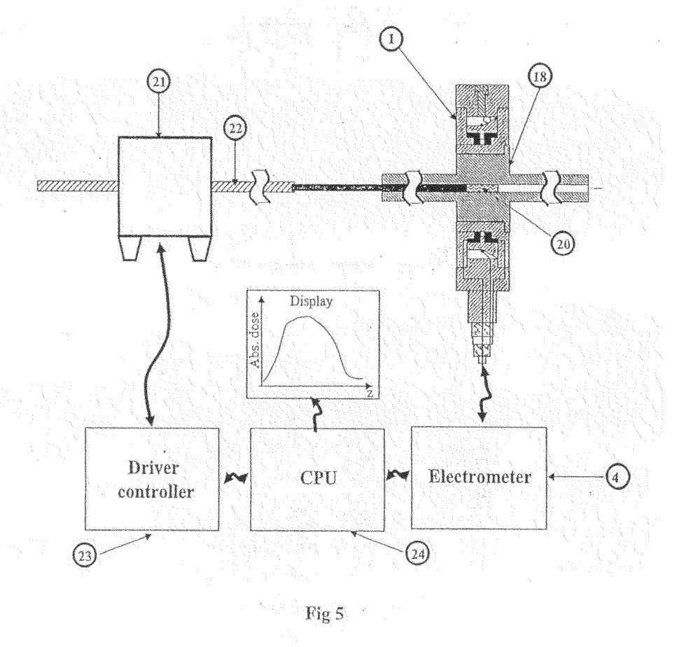

FIG. 5 shows in the form of a block diagram how the ALIC 1, the actuator 21 with its guide screw 22, and the accessory 18 for centring are connected to the control and driver unit 23, the computer 24 and the electrometer.

The sensitive medium of the chamber consists, in the preferred embodiment of the present invention, of a fluid that comprises isooctane, ISO, (C₈H₁₈) and tetramethylsilane, TMS, (Si(CH₃)₄). Monte-Carlo calculations have shown that a mixture of TMS and ISO in the ratio 60/40 by weight provides an optimal energy. response in the range of photon energies from 10 to 1,000 keV. However, the proportions by weight can be changed within the region from 60/40 to 40/60, depending on the interval of photon, energies for which it is desired to optimise the energy response of the detector. Most photon-emitting sources currently used in brachytherapy emit photons with an energy that lies under 30 keV, while some have energies in the region greater than 300 keV (such as Ir-192 and Cs-137), and some have energies in the region greater than 1,000 keV (such as Co-60 and Ra-226). The mixing ratio of the fluids is less critical for, radiation sources that emit beta radiation.

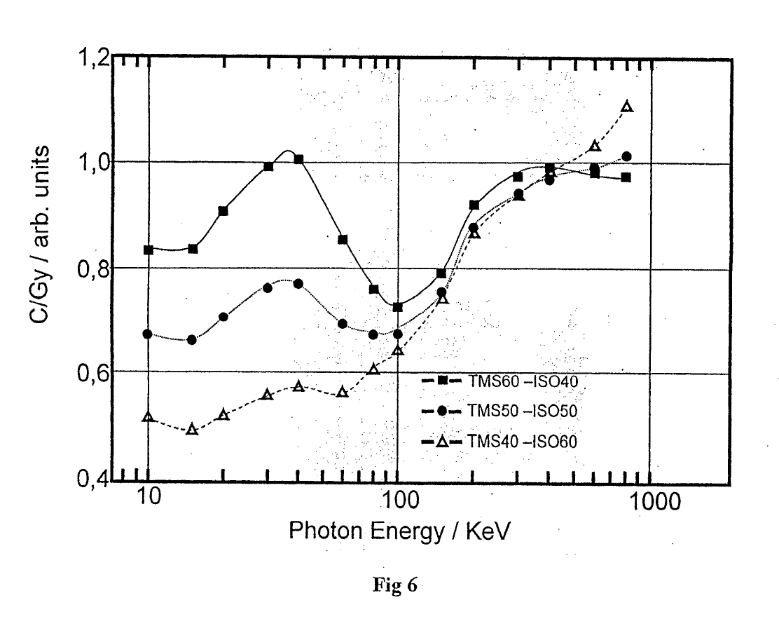

FIG. 6 shows the calculated energy dependence for several mixing ratios of the fluids. The response for a given dose absorbed to water is expressed as the ionic charge (in Coulomb) produced, divided by the dose absorbed to water (in Gray). It is preferred that a sensitive medium whose calibration factor is insensitive to variation in energy be used, in order to provide a useful and reliable detector. The mixing ratio should be optimised for the type or types of radiation source for which it is intended that the ALIC will be used.

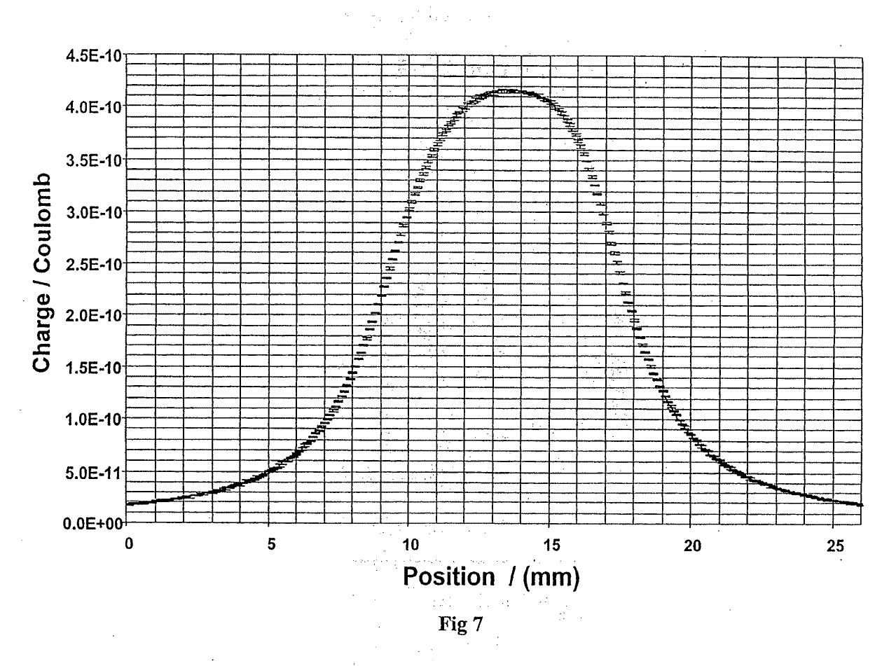

FIG. 7 shows results obtained from an ALIC according to the present invention with a reference distance of 2 mm used to calibrate a CS-137 radiation source for brachytherapy having a diameter of 1 mm, a length of 5 mm and an activity of 30 mCi. This type of radiation source is used for such applications as the treatment of cervical cancer and it belongs to the group of radiation sources for brachytherapy with a medium-high dose rate. The graph shows the response of the ALIC when the radiation source passes the sensitive volume of the ALIC in steps of magnitude 0.1 mm. Each point shows the net charge collected during a period of 2 s. Each point shows the mean value and the standard deviation of ten consecutive measurement scans.

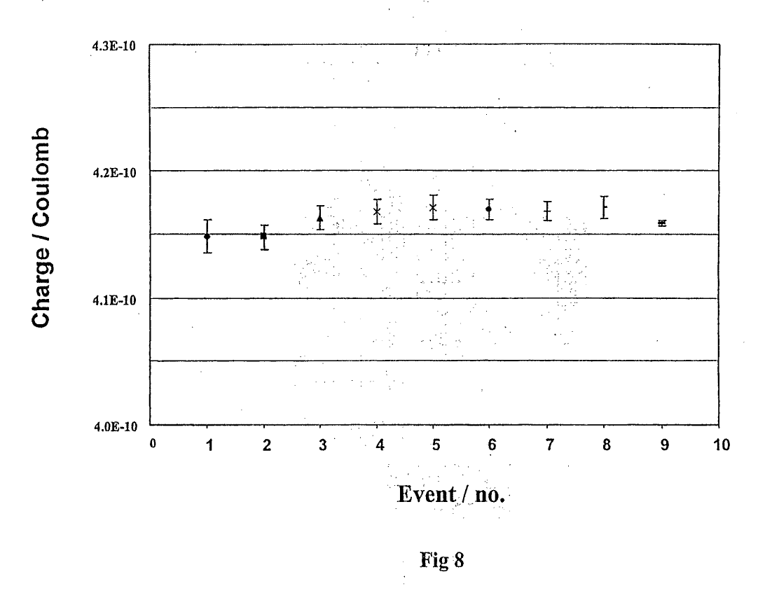

FIG. 8 shows typical results for the calibration stability of an ALIC during one month. Each point shows the mean and the standard deviation of the maximum charge collected, i.e. when the radiation source is axially centred relative to the ALIC, from 10 consecutive scans of a CS-137 radiation source according to FIG. 7. Each measurement occasion is separated from the previous by a time period of 34 days.

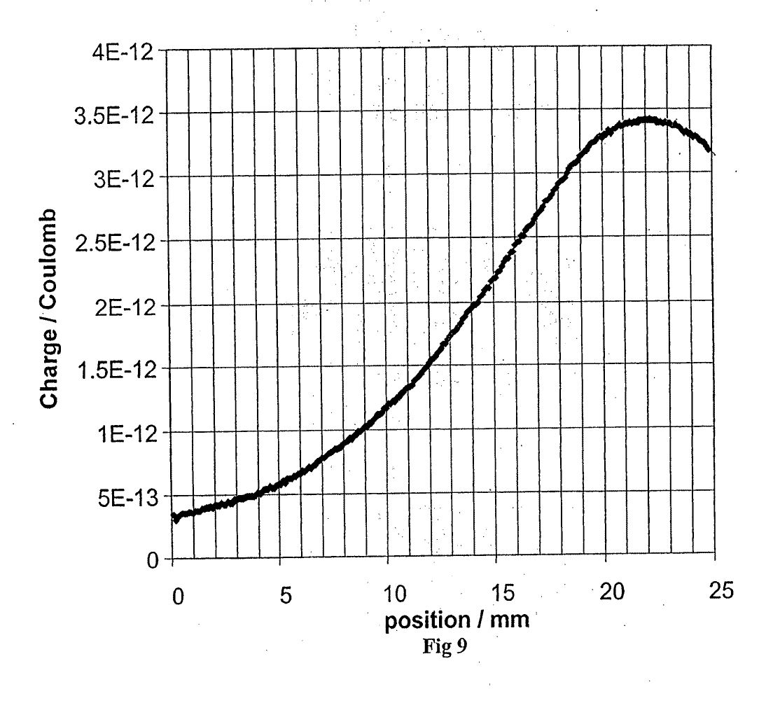

FIG. 9 shows results obtained from an ALIC according to the present invention with a reference distance of 10 mm used to calibrate an I-125 radiation source for brachytherapy having a diameter of 0.8 mm, a length of 4.5 mm and an activity of 1 mCi (37 MBq). This type of radiation source is often used for permanent implantation, and it thus belongs to the group of radiation sources for brachytherapy having a very low dose rate. The graph shows the response of the ALIC when the radiation source approaches and partially passes the sensitive volume of the ALIC in steps of magnitude 0.1 mm. Each point shows the net charge collected during a period of 30 s.

1. An arrangement for the measurement of absorbed dose at a given distance from a radioactive source,
comprising a detector body (1) of ionisation chamber type, comprising two electrode elements (5, 6) separated from each other by a distance and a measuring chamber (7) arranged between these, containing a medium that constitutes the volume that responds to radiation,
a second chamber (12) arranged at a distance from the measuring chamber (7) comprising means for recording changes in the medium,
a flow passage (13) that is arranged to pass through one of the electrode elements (5, 6) and to constitute a connection allowing the flow of fluid between the measuring, chamber (7) and the second chamber (12), and where the detector body (1) comprises a through bore, an aperture (2), in which the radiation source is arranged during measurement, or through which the radiation source is displaced during measurement.

2. The arrangement according to claim 1 in which the aperture (2) is cylindrical.

3. The arrangement according to claim 1 in which the medium is a fluid.

4. The arrangement according to claim 3 in which the medium is a dielectric fluid, a mixture of isooctane and tetramethylsilane.

5. The arrangement according to claim 1, in which the measuring chamber (7) is ring-shaped or cylinder-shaped and is arranged concentrically around the aperture (2), within the detector body (1).

6. The arrangement according to claim 5 in which the measuring chamber (7), including the medium, has the form of a thin-walled, short cylinder.

7. The arrangement according to claim 1, in which the second chamber (12) is ring-shaped or cylinder-shaped and is arranged concentrically around the aperture (2), within the detector body (1).

8. The arrangement according to claim 1, in which the electrode elements (5, 6) are ring-shaped and concentrically arranged around the aperture (2), within the detector body (1).

9. The arrangement according to claim 1, in which means (8, 9) are arranged to limit, together with the electrode elements (5, 6), the measuring chamber (7).

10. The arrangement according to claim 1, in which a protective electrode (16) is arranged within the second chamber (12).

11. The arrangement according to claim 10 in which the protective electrode (16) is positioned such that it is placed in galvanic contact with the fluid in the flow passage (13).

12. The arrangement according to claim 10 in which the protective electrode (16) has the form of a ring.

13. The arrangement according to claim 1, in which an exchangeable accessory (18) is arranged in the aperture (2), and which in turn comprises a concentric aperture (19) for centring the radiation source at a fixed radial distance from the measuring chamber (7).

14. The use of the arrangement according to claim 1, for the measurement of radiation dose at a given distance from a cylindrically shaped radiation source.

15. The use of the arrangement according to claim 14 in which the radiation source has the form of a wire.

16. The use of the arrangement according to claim 14 in which the radiation source is a gas or a fluid.

17. The use of the arrangement according to claim 1, for the calibration of radiation sources for brachytherapy.

18. The use of the arrangement according to claim 1, for monitoring the activity concentration of flowing radioactive gas or fluid, by passing the gas or fluid through the aperture (2, 19).
